(19) United States
(12) Patent Application Publication
(10) Pub. No.: US 2009/0288426 A1
(43) Pub. Date: Nov. 26, 2009

(54) Method and System for Delivering Gas to Consumers, and Use Thereof

(76) Inventors: Dag Lilletvedt, Paradis (NO); Tomas Fiksdal, Bergen (NO)

Correspondence Address: CARELLA, BYRNE, BAIN, GILFILLAN, CECCHI,;STEWART & OLSTEIN, 5 BECKER FARM ROAD, ROSELAND, NJ, 07068, US

(21) Appl. No.: 12/309,064

(22) PCT Filed: Jul. 3, 2007
(86) PCT No.: PCT/NO2007/000253

§ 371 Date: Apr. 17, 2009

(30) Foreign Application Priority Data
Jul. 3, 2006 (NO) 2006 3084

(51) Int. Cl. F17C 9/02; F25B 19/00

(52) U.S. Cl. 62/50.2; 62/51.1

(57) ABSTRACT

A method for delivery of cryogenic combustible gases to users is described, where the combustible gas is kept in one or more storage tanks (10, 20) in a liquid state, such as LNG, as said number of tanks are arranged to be filled up after they are emptied at the delivery to the users, and where a conduit (22, 24) leads gas in liquid state by way of an evaporator to said users. The method is characterized by the following steps: that the storage tanks (10, 20) are mobile and movable tanks which, when empty, are disconnected from the conduits (22, 24) and transported away for refilling of liquid gas, and thereafter reinstalled and reconnected to the conduits (22, 24); that a system is used which perform a switching between the tanks (10, 20) by means of adapted valve systems (40, 47, 49, 42, 51, 53) so that two or more mobile tanks may be used simultaneously in the system, and where one of said tanks is emptied of combustible gas before the other is emptied, where said switching is arranged to be carried out automatically; that systems (60, 62, 64, 66) are used to prevent unwanted pressure build-up in the mobile tanks (10, 20); and that systems (21, 23) are used for quick disconnection and connection of the tanks (10, 20). A system is also described, and use of the present invention for storage and transport of liquid gasses such as LNG gas, oxygen, nitrogen or other industrial gasses, for supplying industry and private households.

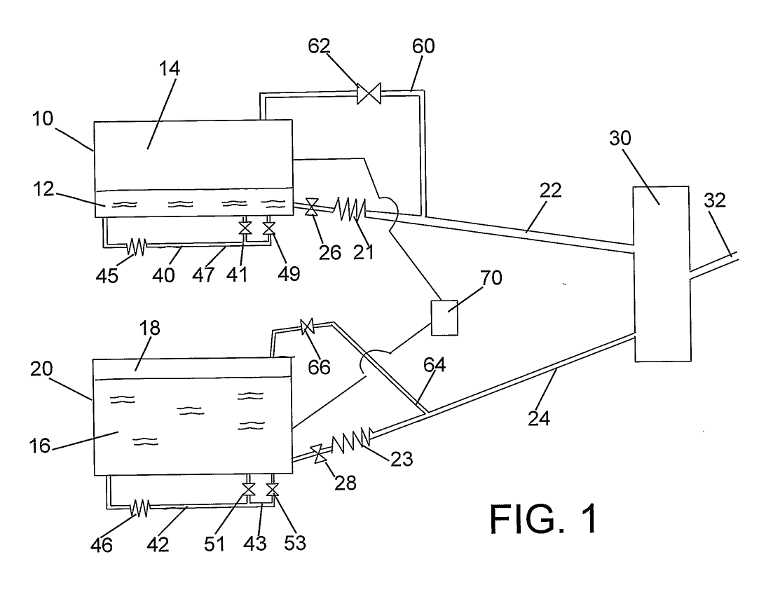

The present invention relates to a method and a system for delivery of cryogenic combustible gasses to users, where the combustible gas is kept, in liquid state such as LNG, in one or more storage tanks, as said tanks are arranged to be filled up after they are emptied at the delivery to the users, and where a conduit leads gas in liquid state by way of an evaporator to said users.

In particular the invention concerns the operation of a system where the gas is delivered in liquid state from the tank to an evaporator, and is converted to a gaseous state prior to further delivery to a user by conventional means. The invention is aimed at providing new solutions for a system of storage tanks constructed in a manner allowing detachment from the remaining system for transport to filling, return, and reattachment.

Also described are uses of the principles behind the given methods and the system.

Cryogenic gasses are meant to be gasses that liquefy by cooling to very low temperatures. For example, natural gas liquefy at −162° C. at atmospheric pressure. One of the savings afforded by liquefying and handling the natural gas until it reaches the user as liquid gas, is that the liquid state has a volume that is approximately 625 times smaller that that of the gaseous state.

The present invention is aimed at providing a system for unmanned mechanical switching between different storage tanks of said type combustible gas, enabling a tank to be completely emptied before the withdrawal of liquid form the next tank is automatically initiated.

Further, one aims at providing systems that can ensure that tanks that would normally require, for reasons of safety, closing of the terminal in the event of a gas leak, may be detached when the tank is empty without requiring the rest of the terminal to be closed.

One also aim at providing a system that can prevent pressure from building up in the tanks during time periods of low consumption of gas.

The invention thus concerns gasses that must be in a cooled down state in order to be kept liquid, and which require functions for closing down the gas terminal in case of a leak. The gas is delivered through conduits and pipes from a tank where it is kept in liquid state. Examples of such gases may comprise LNG (Liquefied natural Gas) and liquid oxygen, but the invention may also be used for liquid nitrogen and other cryogenic gasses.

### Prior Art

The delivery systems for such gases usually comprise a separate large tank for transport, and a separate tank for storage of the liquid gas. Such systems are known where the tank is a stationary tank, which at regular or irregular intervals is emptied of liquid gas, and must be re-supplied. The supplying may take place by a tank truck shaped especially for this purpose, which can transport liquid gas and fill the stationary tank.

According to other solutions, the tank for liquid gas may itself be mobile. When the tank is empty, it is disconnected and transported to a filling station for refilling of liquid gas. This solution is however only used for non-combustible gasses where there are no requirements of automatic shut down of the installation in the event of gas leaks, or continual delivery of gas. In accordance with the invention this is solved (as will be shown) by mounting a fail-safe stop valve on the tank, and connecting a quick release coupling to a stationary safety system. The principle of fail-safe stop valves is known from stationary tanks, but has not been applied to mobile tanks because it requires connection of either pressurized air, electricity, or hydraulics in order to allow flow from the tank.

There is a big disadvantage with such conventional solutions, in that when the mobile tank is disconnected for transport to the filling station and refilling, the end users will not have access to the gas product. This can be a large disadvantage for both businesses and private consumers.

One of the aims of the present invention is to enable a continuous gas supply.

A number of solutions are being used in order to switch combustible gasses between two containers. Known solutions for this purpose concerns gases under high pressure (for example CO₂ and CNG=compressed natural gas), or gasses that behaves like liquid when under pressure (for example propane and butane). Such solutions have however not been applied to gasses that require cryogenic temperatures in order to remain liquid.

It is also technically known to use a so-called “economizer” system in order to prevent unwanted build up of pressure in the tanks. This is practiced on stationary tanks, and in short comprises to use, for the users, gas in the gaseous state instead of gas in the liquid state when the pressure rises above a given set point. In accordance with the present invention the gas is lead from the upper gas volume in the tank directly through the evaporator and out for delivery for consumption. In order to use a tank as both a stationary and a mobile tank this technology is applied according to the invention in order to combine the characteristics of both a stationary and a mobile tank.

The present invention is aimed at providing a solution for using mobile tanks both for transport, storage and delivery of fuel gas in such a manner that the end user still has continual access of delivered gas, even when the tank is transported somewhere else for refilling, and where there simultaneously may be carried out mechanical switching ensuring that one of the mobile tanks is completely emptied before the delivery/emptying from one of the other tanks is initiated. In addition, the present invention will ensure that the safety systems for shutdown of the terminal is not unduly triggered during the change of mobile tanks, and that the tanks do not experience an undue pressure build up.

The method according to the present invention is characterized by the following steps: that the storage tanks are mobile and movable tanks that, when empty, is disconnected from the conduits and transported away for refilling of liquid gas, and then reinstalled and reconnected to the conduits; that a system is used which perform a switching between the tanks by use of a suitable valve system, so that two or more mobile tanks may be used in the system at the same time, where one of said tanks is emptied of combustible gas before the other one is emptied, where the switching is arranged to be carried out automatically; that systems are being used to avoid unintended pressure build up in the mobile tanks; and that systems are being used for quick release and connection of the tanks.

According to a preferred embodiment of the method the gas pressure in the tanks is kept at a higher, respectively lover, pressure, as the delivery of liquid LNG is carried out from the tank with the highest pressure, while delivery from the tank with lover pressure is kept closed off.

Preferably switching of the delivery from the first tank to delivery from the other tank happens between when the gas pressure in the first tank has dropped below a higher pressure, more preferably when the tank is empty of LNG.

According to another preferred embodiment each tank can alternately be kept at a higher or lover gas pressure by two separate outlet conduits with appurtenant stop valves fitted for pressure regulation of the respective gas volumes to said higher or lover pressure, as liquid is removed by one or the other vent to a common conduit with a evaporator unit that produce vapour from the LNG liquid and lead the vapour back to the gas volume in the tank.

According to another preferred embodiment each of the pressurizes can be adjusted to either a high or low pressure by manual vents arranged upstream of the pressure regulating valves.

Preferably each tank comprises an economizer solution which prevent undesired pressure build-up, as when the pressure gets too high in the gas volume, where the gas is conducted directly in the conduit to the evaporator and onwards directly to consumption, and the too high pressure is given by a preset set point.

According to yet another embodiment each tank comprise a flexible quick connection where with the tanks may easily be disconnected from their conduits to the evaporation unit.

Preferably, the conduits comprise automatic emergency stop valves arranged upstream of said quick connections.

Alternately, when refilling of a storage tank is needed, the storage tank is released from the flexible connection, and the system for emergency closing is temporarily disconnected, after which the tank is lifted up on a transport means, such as a side loader, for transport to a depot for filling, and then returned for connection to the system.

The system according to the invention is characterized by the features given in the independent claim 10, and the dependent claims 11-16.

According to the invention the system and method is used for supplying, storage and transport of liquid cryogenic gases for further delivery in gas phase for industrial purposes and other users, in particular for a delivery system for LNG (Liquefied Natural Gas) for delivery to industry and private households.

The invention shall be explained further with reference to the FIGURE, which illustrate the invention when 2 mobile storage tanks are used. It is however not limited to two tanks, as more tanks may be used in the system and connected in the same manner as the two tanks which are especially described according to the invention.

The FIGURE shows the 2 mobile storage tanks 10 and 20, which are used both as transport units and storage units for the liquid gas. The tanks are arranged for storage and delivery of liquid natural gas, LNG, or other cryogenic gasses, to the users, as the delivery conduit from an evaporator 30 is suggested at 32. Inside the two tanks 10 and 20 the liquid and gas phases are shown at 12, 14, respectably 16, 18. In this case tank 10 is about to be emptied of LNG while the tank 20 is the reserve tank. This is illustrated on the FIGURE by the larger gas volume 14 in tank 10, which thus is about to be emptied. Moreover, each mobile storage tank 10, 20, is mounted in a ISO frame for securing and protection of the storage tank during storage and transport.

Tanks 10 and 20 are connected to a conventional evaporation unit 30 by conduits 22 and 24, in that evaporating unit 30 converts the liquid gas to a gas state ready for usage for further delivery through conduit 32. Right by the tanks 10, 20, on each conduit 22, 24 there is connected a flexible quick connector 21, 23, by which tanks 10, 20 may be easily disconnected from their conduits 22, 24, and to the evaporator unit 30. Close to the tanks the conduits 22, 24 further comprise automatic emergency stop valves 26, 28, which close down all LNG delivery when abnormal situations arise in the installation. The system is mainly arranged so that delivery of LNG occurs only from one of the tanks. But it may also be arranged for delivery from both tanks simultaneously.

Each of the tanks 10, 20 comprise a pressure build up system 40 and 42, which is applied to maintain the correct gas pressure inside the tanks (in volumes 14, 18). This system includes an outlet conduit 41, 43, which may let out part of the LNG liquid from tank 10, 20, and in the respective evaporators 45, 46 the liquid is converted to gas and led up into the gas volumes 14, respectively 18, so that the pressure in these volumes may be controlled.

To start with the system is arranged so that the switching between emptying tank 10 and emptying tank 20 is regulated in such a manner that the tank with the highest pressure is the active tank being emptied. In other words, the system itself is arranged so that delivery may occur from whichever tank has the higher pressure. According to an example the pressure in gas volume 14 in tank 10 may be set at 8 barg, while the pressure in gas volume 18 in tank 20 is set at 6 barg.

The adjustment of this gas pressure in tank 10 may occur by that the liquid removal to conduit 40 may happen between two conduits with pressure regulating valves 47, respectively 49, as one of 47 may be set at allowing liquid into the evaporator unit in order to maintain the high pressure (for instance 8 barg), while valve 49 is kept closed. The other valve 49 may be arranged to let in liquid to the evaporator in order to maintain the lover pressure (for example 6 barg).

In the other tank 20 there is also connected to conduit 42 two outlet conduits from the bottom of tank 20 with respective pressure regulating valves 51, 53, which is lead onwards into a common conduit 42 through an evaporator 46. Also these valves 51, 53 are set for the higher (8 barg), respectively lover (6 barg) pressure, as for the valves connected to tank 10. When the 8 barg valve for the one tank 10 is activated, the 6 barg valve is simultaneously activated for the other tank 20.

The delivery system is arranged so that the switching for delivery from tank 20 occurs when the pressure in tank 10 falls below the higher pressure, for example 8 barg, when tank 10 is empty. With these cryogenic gasses the pressure in volume 14 in tank 10 (and in volume 18 in tank 20) will keep at the set pressure until the tank is completely empty.

Each of the pressurizers 40, 42 may be set for either a high or low pressure by manual valves upstream of the pressure regulating valves 47, 49, 51, 53.

When tank 10 delivers LNG through conduit 22 to the evaporator 30, the vapour pressure in volume 14 is kept at the higher pressure, and the in advance set valve 47 may, if needed, deliver liquid to the evaporator 45 in order to maintain this pressure. At the same time the vapour in volume 18 in the other tank 20 is kept at the lover pressure by operation of the pressure-regulating valve 53, so that all delivery to the evaporator is only occurring from tank 10.

In order to ensure such a fire hazardous installation against malfunctions the tanks 10, 20 are connected to a local emergency stop circuit 70, so that the tanks are isolated in case of a gas detection through automatic closure of the emergency stop valves 26, 28.

The installation according to the invention comprises a safety system that makes it possible for every disconnection of conduits in the installation, such as the disconnection of one of the tanks, not to lead to a total shutdown. In accordance with the invention the installation is therefore constructed so that when for example tank 10 is filled, and the flexible quick connection 21 is disconnected, the operator retrieving tank 10 must himself actively disconnect the safety system for the conduits from this tank, during the time the disconnection is occurring.

As previously mentioned the mobile tanks 10, 20 are equipped with an economizer solution that prevents unwanted pressure build-up. A conduit 60 including a valve 62 is connected to the upper side of the tank (in other words from the upper gas volume 14 of the tank) and leads in on the conduit 22 so that LNG in gas state, when the pressure is too high, may be let directly in onto conduit 22 to the evaporator 30 and onwards for direct consumption. This may happen when the gas pressure in the storage tank 10 rises above a given set point.

The corresponding conduit 64 with valve 66 connects the gas volume with conduit 24 for delivery of gas from gas volume 18 in tank 20.

By putting tank 10 in high pressure modus and tank 20 in low pressure modus, tank 10 will be emptied first. When tank 10 is empty the gas pressure in tank 10 will fall, and gas from tank 20 will be automatically fed into the evaporator 30 by the flexible hose in 24.

Tank 10 can then be transported away for refilling by carrying out said disconnection. When the tank is transported back the driver or another operator may choose to empty tank 20 the next time by switching the low and high pressure modus (valves) 47, 49, 51, 53 on the two tanks 10, 20, or, he may manually adjust the system so that tank 10 is still emptied first.

The invention requires that the liquid act as a gas under normal conditions, and is stored on pressurized tanks in a liquid state. In accordance with the invention this gas pressure is used to drive the liquid gas out through the conduit 22 (or 24) and to the evaporator 30 and onwards to the gas consumers through conduit 32. Additionally, one may regulate and build up the pressure in the volumes 14, 18 by help of the conventional pressure build-up systems 40 and 42.

The pressure in the two tanks 10, 20 is not dependent on the exterior pressure and temperature, unlike by gases in a gas state under pressure (like for instance compressed CO₂), and unlike gasses in a liquid state due to applied pressure (like propane).

According to the example in the FIGURE, the invention is shown by use of two tanks 10, 20, but it is of course given that in the system there may be connected also 3 or more tanks with liquid LNG, which are arranged to be equipped and operated as explained above. This also gives the system an even larger buffer when there for instance is a large consumption of gas form the LNG installation.

1. Method for delivering cryogenic fuel gasses to consumers, where said fuel gas is kept in one or more storage tanks (10, 20) in a liquid state, such as LNG, as said tanks are arranged for refilling after being emptied to the users, and where a conduit (22, 24) leads gas in a liquid state by an evaporator to said user, characterized by the following steps:
that the storage tanks (10, 20) are mobile and movable tanks which, when empty, are disconnected from the conduits (22, 24) and transported away for refilling of liquid gas, and thereafter reinstalled and reconnected to the conduits (22, 24);
that a system is used which perform a switching between the tanks (10, 20) by means of adapted valve systems (40, 47, 49, 42, 51, 53) so that two or more mobile tanks may be used simultaneously in the system, and where one of said tanks is emptied of fuel gas before the other is emptied, where said switching is arranged to be carried out automatically;
that systems (60, 62, 64, 66) are used to prevent unwanted pressure build-up in the mobile tanks (10, 20); and
that systems (21, 23) are used for quick disconnection and connection of the tanks (10, 20).

2. Method in accordance with claim 1, characterized by that the gas pressure in the tanks (10, 20) is kept at a higher, respectively lover pressure, as delivery of liquid LNG takes place from the tank (10) with the highest pressure, while deliver from the tank with the lover pressure is kept closed off.

3. Method in accordance with claims 1-2, characterized by that the switching between delivery form the first tank (10) to delivery form the second tank (20) occurs when the gas pressure in the first tank (10) drops below a higher pressure, more preferably when the tank (10) is empty of LNG.

4. Method in accordance with claims 1-3, characterized by that each tank alternately may be kept at a higher or lover gas pressure by two separate outlet conduits with appurtenant stop valves (47, 49, 51, 53) adjusted for pressure regulation in the respective gas volumes (14, 18) to said higher or lower pressure, as liquid is removed by one or the other valve, to a common conduit with a evaporator unit producing vapour from the LNG liquid and leading the vapour back to the gas volume in the tank (10, 20).

5. Method in accordance with one of the previous claims, characterized by that each of the pressurizes 40, 42 may be adjusted to either a high or low pressure by manual valves arranged upstream from the pressure regulating valves 47, 49, 51, 53.

6. Method in accordance with one of the previous claims, characterized by that each tank (10, 20) comprise an economizer solution which prevents unwanted pressure build-up, as when the pressure becomes too great in the gas volume (14, 18) gas is lead directly in to the conduit (22, 24) to the evaporator (30) and onward directly for consumption, and the too high pressure is given by a preset set-point.

7. Method in accordance with one of the previous claims, characterized by that each tank (10, 20) comprise a flexible quick connection (21, 23) by which the tanks (10, 20) may be easily disconnected from their conduits (22, 24) to the evaporator unit (30).

8. Method in accordance with one of the previous claims, characterized by that the conduits (22, 24) comprise automatic emergency stop valves (26, 28) arranged upstream of said quick connections (21, 23).

9. Method in accordance with one of the previous claims, characterized by that when it is necessary to fill up a storage tank, the storage tank (10, 20) is disconnected from the flexible conduit (21, 23), and that the system for emergency shut-down (70) is temporarily disconnected, where after the tank (10, 20) is lifted onto a transport means, such as a side loader, for transport to a depot for refilling, and then returned for reconnection to the system.

10. System for delivery of cryogenic combustible gases to users, comprising a number of storage tanks (10, 20) for LNG in liquid state, which is arranged for refilling after emptying, and a conduit (22, 24) that may lead gas in a liquid state to an evaporator and onwards to said users, characterized by that
the storage tanks (10, 20) are mobile and movable tanks which, when empty, is arranged to be disconnected from the conduits (22, 24) and transported away for refilling of liquid gas, and then reinstalled and reconnected to the conduits (22, 24),
that it comprises a system which perform a switching between the tanks (10, 20) by means of adapted valve systems (40, 47, 49, 42, 51, 53) so that two or more mobile tanks may be used simultaneously in the system, and where one of said tanks is emptied of combustible gas before the other is emptied, where said switching is arranged to be carried out automatically;
that it comprises systems (60, 62, 64, 66) to prevent unwanted pressure build-up in the mobile tanks (10, 20); and
that it comprises systems (21, 23) for quick disconnection and connection of the tanks (10, 20).

11. System in accordance with claim 10, characterized by that to keep the gas pressure in each tank at a higher or lower gas pressure, each tank (10, 20) comprises two separate outlet conduits with appurtenant stop valves (47, 49, 51, 53) adjusted for pressure regulation in the respective gas volumes (14, 18) to said higher or lower pressure, as liquid is removed by one or the other valve, to a common conduit with a evaporator unit producing vapour from the LNG liquid and leading the vapour back to the gas volume in the tank (10, 20).

12. System in accordance with one of the previous claims 10-11, characterized by that each of the pressurizes 40, 42 is arranged to be adjusted to either a high or low pressure by manual valves arranged upstream from the pressure regulating valves 47, 49, 51, 53.

13. System in accordance with one of claims 10-12, characterized by that each tank (10, 20) comprise an economizer solution which prevents unwanted pressure build-up, as when the pressure becomes too great in the gas volume (14, 18) gas is lead directly in to the conduit (22, 24) to the evaporator (30) and onward directly for consumption, and the too high pressure is given by a preset set-point.

14. System in accordance with one of claims 10-13, characterized by that each tank (10, 20) comprise a flexible quick connection (21, 23) by which the tanks (10, 20) may be easily disconnected from their conduits (22, 24) to the evaporator unit (30).

15. System in accordance with one of claims 10-14, characterized by that the conduits (22, 24) comprise automatic emergency stop valves (26, 28) arranged upstream of said quick connections (21, 23).

16. System in accordance with one of claims 10-15, characterized by that a mobile storage tank (10, 20) is mounted in a ISO frame for securing and protecting the storage tank during transport.

17. Use of a system and method according to the previous claims, for delivery, storage and transport of liquid gasses, such as LNG-gas, oxygen, nitrogen or other industrial gasses, for supplying industry and private households.
